(19) United States
(12) Patent Application Publication
(10) Pub. No.: US 2025/0174045 A1
(43) Pub. Date: May 29, 2025

(54) SYSTEMS AND METHODS FOR EXTRAPOLATING BEHAVIORS OF INDIVIDUALS IN VIRTUAL SPACES TO THE REAL WORLD

(71) Applicant: Wells Fargo Bank, N.A., San Francisco, CA (US)

(72) Inventors: Krishnamraju V. Penmetcha, Fremont, CA (US); Manesh Saini, New York City, NY (US)

(21) Appl. No.: 18/046,605

(22) Filed: Oct. 14, 2022

(51) Int. Cl. G06V 40/20; G06Q 40/03

(52) U.S. Cl. CPC G06V 40/20; G06Q 40/03

(57) ABSTRACT

Systems, apparatuses, methods, and computer program products are disclosed for utilizing activities of individuals in virtual spaces to supplement information regarding the activities of individuals in the real world in order to determine when and how to engage with an individual. An example method includes training an inference model using historical behavioral data of the individual. The example method further includes establishing a pattern of behavior of the individual, and based on the pattern of behavior, generate actionable steps to be executed for engaging with the individual.

### BACKGROUND

Virtual spaces (e.g., such as the metaverse) are computer-simulated places and/or environments with which users are able to interact via an interface (e.g., a computing device). As individuals spend more time within virtual spaces, these virtual spaces have become a valuable source for user-related information.

### BRIEF SUMMARY

Deciding when and how to engage with an individual (e.g., a bank engaging in financial transactions with an individual) is challenging. With increasing use of the internet, it has become commonplace for an individual to have multiple virtual identities across virtual spaces (e.g., via maintaining one or more accounts and/or profiles across these virtual spaces). For example, an individual may have a virtual identity (e.g., an avatar) in a virtual space (e.g., the metaverse). In the span of one week the individual may participate in activities within the virtual space more often than in the real world. Therefore, the activities of the individual within the virtual space may become just as, or more, indicative of the individual's overall behavior during that week compared to the individual's activities in the real world.

Information regarding the activities of the individual within the virtual space is stored (e.g., in a cloud database). However, despite being able to provide an increased quantity of information regarding an individual's virtual activity and/or presence, such information is currently underutilized.

To better utilize this readily available information regarding an individual's virtual activities and/or presence (e.g., virtual behavioral data), such information may be used to supplement information regarding the activities of individuals in the real world (e.g., real world or non-virtual behavioral data).

Systems, apparatuses, methods, and computer program products are disclosed herein for utilizing virtual behavioral data and non-virtual behavioral data to make more accurate decisions (e.g., predictions) concerned with engaging an individual. As previously mentioned, when an individual interacts with a virtual space, information regarding such interactions (e.g., virtual behavioral data) is stored. The virtual behavioral data may be analyzed, along with non-virtual behavioral data of the individual, by a machine learning model (e.g., an inference model) to establish a pattern of behavior of the individual in a virtual and/or non-virtual space. For example, within a virtual space, if an individual displays interest in certain virtual products but is unable to acquire these virtual products, it may be inferred that the individual may also lack the necessary resources within the real world. This inference may be used as a basis for determining that it may be wise to present various financial products to the individual in the real world. In another example, when an individual engages in risky behavior (e.g., maxes out payment method primarily used by the individual) in a virtual space, the risky behavior in the virtual space may be used as a basis for estimating a risk tolerance of the individual.

In some embodiments, an individual's pattern of behavior in the virtual and/or non-virtual space may be established using an inference model trained using historical behavioral data of the individual. By using this historical behavioral data, the trained inference model may become tailored to the behavioral tendencies of the individual, and thus output more accurate predictions based on future behavioral data of the individual. The predictions made may be further analyzed by the trained inference model to generate recommendations (e.g., actionable steps) on when and how to engage the individual.

Establishing a pattern of behavior based on virtual and non-virtual behavioral data may cause better decisions (e.g., more accurate predictions, recommended actionable steps, etc.) to be made with respect to when and how to engage the individual (e.g., in business transactions) through the increased quantity of available information regarding the activities of the individual.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 shows a block diagram illustrating a system in accordance with an embodiment.

FIG. 2 illustrates a schematic block diagram of example circuitry embodying a device that may perform various operations in accordance with some example embodiments described herein.

FIG. 3 illustrates an example flowchart for utilizing virtual behavioral data and non-virtual behavioral data, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

### Overview

As noted above, methods, apparatuses, systems, and computer program products are described herein that utilizes virtual behavioral data and non-virtual behavioral data to make more accurate decisions (e.g., predictions) concerned with engaging an individual.

Determining whether to engage an individual in the real world generally involves harvesting and then analyzing non-virtual behavioral data (e.g., credit score, income, dependents, spending habits, etc.) of the individual. With the expansion of technology, the Internet has provided a new environment (e.g., a virtual environment), different to that of the real world, in which the individual may exist in and in which the individual may choose to engage with more often than the real world. As the individual interacts with this new virtual environment, information regarding these interactions is stored (e.g., in a cloud database), and therefore made available for future use. For example, with increasing use of the internet, it has become commonplace for an individual to have multiple virtual identities (e.g., exist) across virtual spaces, and therefore, the activities of these virtual identities may indicate the individual's overall behavior just as much as, or more than, the individual's activities in the real world. However, despite there being such a plethora of available information regarding interactions in the new virtual environment, the information regarding these interactions is greatly underutilized.

To better utilize the available information, in some embodiments, activities of the individual in virtual spaces (e.g., virtual behavioral data) may be used to supplement, and/or used in combinations with, information regarding the activities of the individual in the real world (e.g., non-virtual behavioral data). These virtual and non-virtual behavioral data may then be used as input for a trained inference model (e.g., a machine learning model). Based on the input, the trained inference model may establish a pattern of behavior for the individual. Additionally, in some embodiments, the trained inference model may generate recommendations (e.g., actionable steps), based on the pattern of behavior, specifying when and how to engage the individual.

In some embodiments, an inference model may be trained using historical behavioral data of the individual. The historical behavioral data may include historical virtual behavioral data of the individual and historical non-virtual behavioral data of the individual. The historical behavioral data may be harvested for a duration of time (e.g., a month, a year, multiples years, etc.) in which ample historical behavioral data is obtained to efficiently train the inference model. Additionally, in some embodiments, the trained inference model may be retrained using additional and/or different historical behavioral data to obtain an updated inference model (as discussed in more detail below). Upon being retrained, the updated inference model, in turn, may establish an updated pattern of behavior and/or updated actionable steps.

In some embodiments, should there be an insufficient amount of behavioral data of any one individual, a simulation (e.g., a virtual activity) may then be generated for these individuals to complete. Upon completion, the simulation may provide additional virtual behavioral data to supplement the initially insufficient behavioral data.

In some embodiments, non-virtual activities of the individual may be extrapolated based on the individual's virtual activities. In contrast, some embodiments may extrapolate virtual activities of the individual based on the non-virtual activities of the individual.

Although a high-level explanation of the operations of example embodiments has been provided above, specific details regarding the configuration of such example embodiments are provided below.

### System Architecture

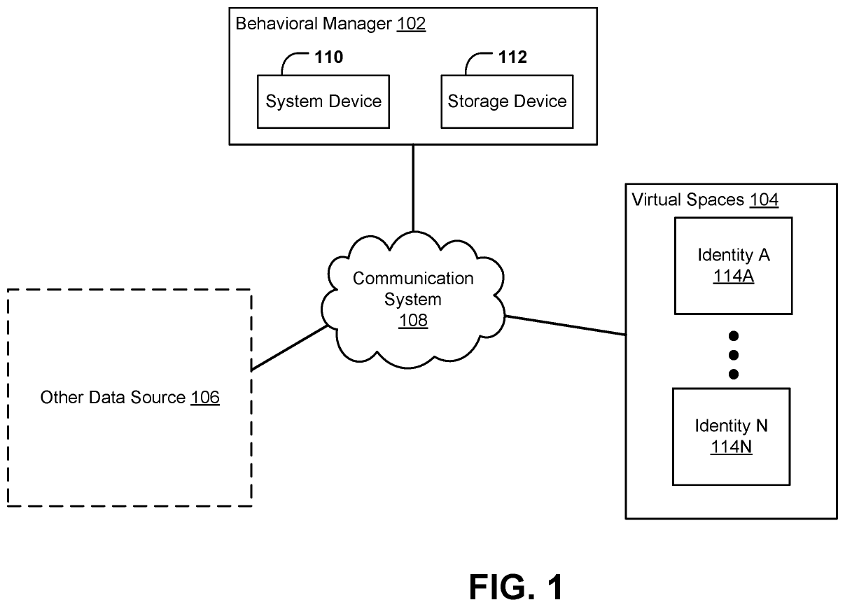

Example embodiments described herein may be implemented using any of a variety of computing devices or servers. To this end, FIG. 1 illustrates an example environment 100 within which various embodiments may operate. As illustrated, a behavioral manager 102 may include a system device 110 in communication with a storage device 112. Although system device 110, storage device 112, and other data source 106 are described in singular form, some embodiments may utilize more than of these components. Additionally, some embodiments of the behavioral manager 102 may not require a storage device 112 at all (e.g., the behavioral manager will use the other data source 106 instead of the storage device 112).

Whatever the implementation, the behavioral manager 102, and its constituent system device(s) 110 and/or storage device(s) 112 may receive and/or transmit information via communication system 108 (e.g., the Internet) with any number of other devices, such as devices executing one or more virtual spaces 104 hosting one or more of identities 114A-114N.

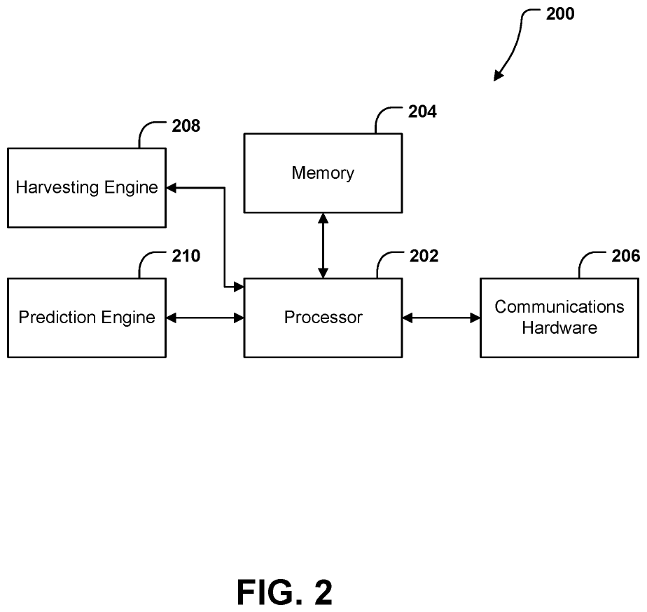

System device 110 may be implemented as one or more servers, which may or may not be physically proximate to other components of behavioral manager 102. Furthermore, some components of system device 110 may be physically proximate to the other components of behavioral manager 102 while other components are not. System device 110 may receive, process, generate, and transmit data, signals, and electronic information to facilitate the operations of the behavioral manager 102. Components of system device 110 are described in greater detail below with reference to apparatus 200 in connection with FIG. 2.

Storage device 112 may comprise a distinct component from system device 110 or may comprise an element of system device 110 (e.g., memory 204, as described below in connection with FIG. 2). Storage device 112 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communication system 108). Storage device 112 may host the software executed to operate the behavioral manager 102. Storage device 112 may store information relied upon during operation of the marker manager 102, such as various databases that may be used by the behavioral manager 102, data and documents to be analyzed using the behavioral manager 102, or the like. In addition, storage device 112 may store control signals, device characteristics, and access credentials enabling interaction between the behavioral manager 102, one or more of identities 114A-114N of virtual spaces 104, and other data source 106.

The virtual spaces 104 may be any type of virtual environment (e.g., a metaverse, a website, an online video game, etc.). The virtual spaces 104 may each store information about one or more of identities 114A-114N created by one or more individuals. For example, assume that a virtual space is an online video game. Users of the online video game may each create one or more digital avatars (e.g., identities 114A-114N) within the online video game environment. These digital avatars are stored by computing devices (e.g., servers) hosting the online video game.

The other data source 106 may be embodied by various computing devices known in the art, such as desktop or laptop computers, servers, server devices, or the like. In particular, the other data source 106 may be configured as a server partitioned to act as a storage device (e.g., a cloud storage server, a remote storage server, etc.).

In some embodiments, the other data source 106 may be configured to store (e.g., in the form of one or more data structures such as a table, a file, etc.) non-virtual behavioral data. The non-virtual behavioral data may specify (i.e., include) information associated with activities of one or more individuals in the real world.

Although FIG. 1 illustrates an environment 100 and implementation in which the behavioral manager 102 interacts with one or more of the virtual spaces 104, and/or the other data source 106, in some embodiments users may directly interact (e.g., operate, control, modify, or otherwise interact to perform the various functions and achieve the various benefits described herein) with the behavioral manager 102 (e.g., via input/output circuitry of system device 110).

### Example Implementing Apparatuses

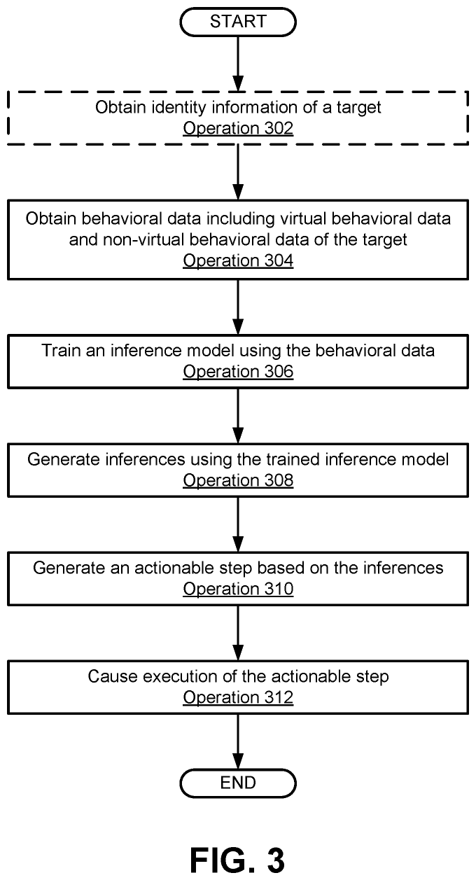

System device 110 of the behavioral manager 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, input-output circuitry of communications hardware 206, harvesting engine 208, and prediction engine 210, each of which will be described in greater detail below. While the various components are only illustrated in FIG. 2 as being connected with processor 202, it will be understood that the apparatus 200 may further comprises a bus (not expressly shown in FIG. 2) for passing information amongst any combination of the various components of the apparatus 200. The apparatus 200 may be configured to execute various operations described above in connection with FIG. 1 and below in connection with FIG. 3.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 112, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor for causing transmission of such signals to a network or for handling receipt of signals received from a network. In some embodiments, the communications hardware 206 may include, for example, interfaces such as one or more ports (e.g., a laser port, a fiber-optic cable port, and/or the like) for enabling communications with other devices.

The communications hardware 206 may include input-output circuitry (not shown) configured to provide output to a user and, in some embodiments, to receive an indication of user input. It will be noted that some embodiments will not include input-output circuitry, in which case user input may be received via a separate device such as a separate client device or the like. The input-output circuitry of the communications hardware 206 may comprise a user interface, such as a display, and may further comprise the components that govern use of the user interface, such as a web browser, mobile application, dedicated client device, or the like. In some embodiments, the input-output circuitry may include a keyboard, a mouse, a touch screen, touch areas, soft keys, a microphone, a speaker, and/or other input/output mechanisms. The input-output circuitry may utilize the processor 202 to control one or more functions of one or more of these user interface elements through software instructions (e.g., application software and/or system software, such as firmware) stored on a memory (e.g., memory 204) accessible to the processor 202.

The harvesting engine 208 may be any means such as a device or circuitry embodied in either hardware or a combination of hardware and software that is configured to harvest virtual and non-virtual behavioral data of an individual. The harvesting engine may utilize processor 202, memory 204, or any other hardware component included in the apparatus 200 to perform these operations, as described in connection with FIG. 3 below. The harvesting engine 208 may further utilize communications hardware 206 to gather data from a variety of sources (e.g., storage 112 and/or other data source 106). More specifically, for example, the harvesting engine 208 may utilize communications hardware 206 to harvest an individual's virtual and non-virtual behavioral data.

Finally, the apparatus 200 further comprises a prediction engine 210 configured to include an inference model that may establish a pattern of behavior for the individual based on the individual's virtual and non-virtual behavioral data. The prediction engine 210 may further be configured to generate an output specifying a recommended actionable step based on the individual's pattern of behavior. The prediction engine 210 may utilize processor 202, memory 204, or any other hardware component included in the apparatus 200 to perform these operations, as described in connection with FIG. 3 below. In some embodiments, the prediction engine 210 may further utilize communications hardware 206 to receive data from a variety of sources (e.g., the harvesting engine 208, storage device 112 and/or other data source 106), and in some embodiments may utilize processor 202 and/or memory 204 to establish a pattern of behavior for an individual.

Although components 202-210 are described in part using functional language, it will be understood that the particular implementations necessarily include the use of particular hardware. It should also be understood that certain of these components 202-210 may include similar or common hardware. For example, the harvesting engine 208 and the prediction engine 210 may each at times leverage use of the processor 202, memory 204, communications hardware 206, or input-output circuitry of communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the harvesting engine 208 and the prediction engine 210 may leverage processor 202, memory 204, communications hardware 206, or input-output circuitry of communications hardware 206 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, communications hardware 206 or input-output circuitry of communications hardware 206 for enabling any functions not performed by special-purpose hardware elements. In all embodiments, however, it will be understood that the harvesting engine 208 and the prediction engine 210 are implemented via particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. Thus, some or all the functionality described herein may be provided by third party circuitry. For example, a given apparatus 200 may access one or more third party circuitries via any sort of networked connection that facilitates transmission of data and electronic information between the apparatus 200 and the third-party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a flowchart.

### Example Operations

Turning to FIG. 3, an example flowchart is illustrated that contains example operations implemented by example embodiments described herein. The operations illustrated in FIG. 3 may, for example, be performed by system device 110 of the behavioral manager 102 shown in FIG. 1 which may in turn be embodied by an apparatus 200, which is shown and described in connection with FIG. 2. To perform the operations described below, the apparatus 200 may utilize one or more of processor 202, memory 204, communications hardware 206, input-output circuitry of communications hardware 206, harvesting engine 208, prediction engine 210, and/or any combination thereof. It will be understood that user interaction with the behavioral manager 102 may occur directly via input-output circuitry of communications hardware 206, or may instead be facilitated by a separate entity, not expressly shown in FIG. 1, and which may have similar or equivalent physical componentry facilitating such user interaction.

Turning first to FIG. 3, example operations are shown for utilizing virtual behavioral data and non-virtual behavioral data to make more accurate decisions (e.g., predictions, determinations, etc.) concerned with engaging an individual.

As shown by operation 302 (marked with broken lines in FIG. 3 to indicate that this operation may be optional, discussed further below), the apparatus 200 includes means, such as communications hardware 206, or the like, for obtaining identity information of a target (e.g., an individual) (also referred to herein as “target individual”). Identity information may be information used to verify an individual. More specifically, identity information may be used to verify the target's identity in the real world as well as providing enough information that the target's identity in virtual space may also be verified. The identity information may include: a driver license number, a credit card number, a social security number, one or more biometrics, contact information, or the like. In some embodiments, the identity information may also include one or more virtual identities of the target. Virtual identities may be identities utilized by an individual in virtual space. Each of the target's virtual identities may be embodied by one or more of: a digital avatar, a profile image, an email address, a username, and/or any other unique identifier used to identify the target within one or more virtual spaces.

In some embodiments, the identity information may be self-reported by the target (e.g., using input-output circuitry of the communications hardware 206). Alternatively, the identity information may be input (via the input-output circuitry of the communications hardware 206) by a third-party (e.g., a bank of the target) receiving the identity information from the target. Once received by the communications hardware 206, the communications hardware 206 may provide the identity information to a harvesting engine 208 and/or the communications hardware 206 may store the identity information in storage available to the behavioral manager 102 (e.g., storage 112) for future use by the behavioral manager 102.

For example, assume that the target is a client of a bank. The target may go to a physical location of the bank to directly enter (via a terminal at the bank linked to the behavioral manager 102) the identity information. The target may also provide an employee of the bank with the identity information. The employee of the bank will then enter (via the terminal at the bank) the identity information for the target. The target's biometrics may also be obtained at the physical location and provided to the behavioral manager 102 via the terminal.

As shown by operation 304, the apparatus 200 includes means, such as harvesting engine 208, or the like, for obtaining behavioral data including virtual behavioral data and non-virtual behavioral data of the target. The harvesting engine 208 may obtain the virtual behavioral data and non-virtual behavioral data of the target using a target's identity information (e.g., the identity information obtained in operation 302). Non-virtual behavioral data includes at least one of an income, a credit score, a loan history, clearinghouse data, asset information, dependents information, a transaction history of the target, or the like. Virtual behavioral data includes any information concerning activities performed by the target within a virtual space (e.g., virtual transactions, chat logs from virtual chat rooms, or the like). As other examples of virtual behavioral data, all of the above-discussed example non-virtual behavioral data would be considered virtual behavioral data when they are performed within a virtual space.

To obtain behavioral data of the target, in some embodiments, harvesting engine 208 may request a target's virtual behavioral data from virtual spaces (e.g., virtual spaces 104) in which the target has virtual identities (e.g., identity 114A-114N). Such virtual spaces may be identified based on the identity information provided by the target (e.g., in operation 302). In addition, in some embodiments, harvesting engine 208 may request non-virtual behavioral data of the target from other data source (e.g., other data source 106, which may include Transunion credit reports, the target's bank, or the like).

In some embodiments, behavioral data of the target may be harvested (continuously or at regular intervals) over a period of time (e.g., a month, a year, several years, etc.). More specifically, as the target participates in more and more activities (virtually and/or non-virtually) the harvesting engine 208 may update the harvested behavioral data to include these additional activities. Alternatively, in some embodiments, the harvesting of behavioral data may not be continuous. More specifically, behavioral data may be harvested once, despite the target participating in additional activities after the behavioral data has been harvested.

Additionally, in some embodiments, behavioral data harvested over a period of time may also be referred to as historical behavioral data and may be used (as training data) to train an inference model. Training of the inference model is discussed in more detail below in operation 306.

In some embodiments, if it is determined (e.g., by the inference model) that there is an insufficient amount of behavioral data for generating inferences of the target's pattern of behavior, the harvesting engine 208 may then generate a virtual activity. The virtual activity may be a simulation (e.g., a financial simulation activity such as a class and/or lecture for providing financial education to the target) used to gain additional virtual behavioral data to supplement the insufficient amount of behavioral data. The virtual activity may be provided to the target (e.g., via the communication hardware 206 transmitting one or more messages including a form of access to the virtual activity). The supplemental virtual behavioral data may be added to, for example, a financial simulation profile of the target upon the target's completion of the virtual activity. The harvesting engine 208 may then obtain the supplemental virtual behavioral data from the financial simulation profile of the target. By doing so, the quantity of available information regarding the activities of the target may be advantageously increased and efficiently utilized.

As shown by operation 306, the apparatus 200 includes means, such as prediction engine 210, or the like, for training an inference model using behavioral data of the target. The inference model may be a machine learning model (e.g., a neural network, a regression model, etc.) trained to establish a pattern of behavior of the target, to be discussed further below. The behavioral data used to train the inference model may be harvested over a period of time, and as mentioned above, may be referred to as historical behavioral data of the target. By using this historical behavioral data, the trained inference model may become tailored to the behavioral tendencies of the target, and thus output more accurate inferences based on future behavioral data of the target. As one example, the historical behavioral data may be a time series including activities performed by the target over a predetermined period of time (e.g., a month, a year, several years, etc.).

In some embodiments, as additional historical behavioral data is harvested (continuously or at regular intervals), the inference model may be retrained, resulting in an updated inference model that may provide more accurate inferences (e.g., more accurate predictions about the target's pattern of behavior).

As shown by operation 308, the apparatus 200 includes means, such as prediction engine 210, or the like, for generating inferences using the trained inference model. These inferences may establish a pattern of behavior of the target. More specifically, the trained inference model may take behavioral data of the target as input data and may generate patterns of behavior of a target as output data.

In some embodiments, the target's pattern of behavior may be a statistical probability of whether the target will conduct one or more virtual and/or non-virtual activities (e.g., buying a car in virtual and/or non-virtual space) represented by a percentage, a number, a letter, etc. More specifically, for example, a trained inference model may interpret behavioral data of a client of a bank as evidence of very risky behavior (e.g., maxing out the entirety of the client's payment methods). The inference model may have a scale to reference when establishing the pattern of behavior. The scale, for example, may be from 1 to 10, where 1 represents low risk and 10 represents high risk. Therefore, the inference model may output the number 10 as a representation of the client's pattern of behavior, subsequently establishing the client's pattern of behavior as high risk.

As shown by operation 310, the apparatus 200 includes means, such as prediction engine 210, or the like, for generating an actionable step based on the inferences. Once the pattern of behavior is established for the target, the trained inference model may further generate actionable steps (e.g., ways to engage the target) based on the established pattern of behavior. More specifically and continuing the above example where the target is a client of a bank, assume that the client's pattern of behavior indicates that the client consistently makes bad financial decisions (e.g., overspending virtual currencies, purchases bad stock options, etc.), the trained inference model may generate (as an actionable step) recommendations for the bank to offer financial education and/or assign a financial adviser to the client to improve the client's financial knowledge.

In another example, if an individual in a virtual space displays interest in certain virtual products but is unable to acquire those virtual products, it may be inferred that the individual also lacks resources to obtain products in the real world. to the trained inference model may generate recommendations for the bank to present various financial products (e.g., loans) to the individual in the real world.

In some embodiments, the actionable step may be to harvest more behavioral data of the target (as described above in operation 304 when it is determined that there is insufficient amount of behavioral data). To harvest more behavioral data the predictions engine 210 may use communications hardware 206 to request that harvesting engine 208 generate a virtual activity (discussed previously above in operation 304) and/or to request that harvesting engine 208 harvest more data from various sources (e.g., virtual spaces 104 and/or other data source 106). In such an instance, after additional behavioral data is harvested, updated inferences and updated actionable steps may be generated.

As shown by operation 312, the apparatus 200 includes means, such as prediction engine 210, or the like, for causing execution of the actionable step. Depending on what the actionable step specifies, the way in which the actionable step is executed may vary. For example, if the actionable step is to offer financial education to a client of a bank, execution of the actionable step may be to cause such recommendations to be displayed to an employee of the bank. In this scenario, the bank may cause the client to receive a notification (e.g., by sending the notification to the client) offering classes that teach the client about financial education. As another example, if the actionable step is to assign a financial advisor to the client, the prediction engine 210 may cause the bank's internal computing systems to automatically select and assign a financial advisor to the client.

As described above, example embodiments provide methods and apparatuses that more effectively (e.g., better) utilizes activities of individuals in virtual spaces to supplement information regarding the activities of individuals in the real world in order to determine when and how to engage with an individual (e.g., the target). Example embodiments thus provide tools that overcome the problems and restrictions associated with deciding when and how to engage an individual, while also advantageously being able utilize underutilized behavioral data to make more accurate predictions regarding the individual's behavior.

As these examples all illustrate, example embodiments contemplated herein provide technical solutions that solve real-world problems faced when determining how best to engage with individuals. And while activities of an individual in the real world have historically been used to predict behavior of the individual, the recently exploding amount of information that can be harvested from virtual spaces made available by recently emerging technology (e.g., the metaverse) today has resulted in a plethora of newly available behavioral data. Example embodiments described herein thus represent a technical solution to the above-referenced real-world problems.

FIG. 3 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
obtaining, by a harvesting engine of a behavioral manager, non-virtual behavioral data relating to a financial position of a target individual and virtual behavioral data by the target individual;
training, by a prediction engine of the behavioral manager, an inference model using the non-virtual behavioral data and the virtual behavioral data;
making, by the prediction engine and using the trained inference model, a determination that the target individual is likely to conduct a non-virtual activity;
generating, by the prediction engine, an actionable step based on the determination; and
causing, by the prediction engine, execution of the actionable step.

2. The method of claim 1, wherein obtaining the behavioral data further comprises:
generating, by the harvesting engine, a virtual activity;
providing, by communications hardware of the behavioral manager, the virtual activity to the target individual; and
obtaining, by the harvesting engine, the virtual behavioral data as the target individual completes the virtual activity.

3. The method of claim 2, wherein the virtual activity is a financial simulation activity, the virtual behavioral data is obtained from a financial simulation profile of the target individual, and the financial simulation profile is generated as the target individual completes the financial simulation activity.

4. The method of claim 1, wherein making the determination that the target individual is likely to conduct the non-virtual activity further comprises:
obtaining, by the harvesting engine, a first virtual behavior of the target individual, wherein the first virtual behavior is one of the virtual behavioral data; and
generating, by the inference model trained by the prediction engine, the non-virtual activity based on the first virtual behavior.

5. The method of claim 4, wherein generating the actionable step further comprises:
generating, by the prediction engine and for the target individual, an output including at least one of:
a service associated with the non-virtual activity;
a course of action associated with the non-virtual activity; and
a virtual activity associated with the non-virtual activity.

6. The method of claim 5, wherein causing execution of the actionable step further comprises:
providing, by communications hardware of the behavioral manager, the output to the target individual; and
in an instance where the virtual activity associated with the non-virtual activity is provided to the target individual:
obtaining, by the harvesting engine, supplemental virtual behavioral data based on the target individual's completion of the virtual activity;
retraining, by the prediction engine, the inference model using the supplemental virtual behavioral data to obtain an updated inference model;
generating, by the prediction engine and using the updated inference model, an updated actionable step for the non-virtual activity; and
causing, by the prediction engine, execution of the updated actionable step.

7. The method of claim 4, wherein the non-virtual behavioral data comprises at least one of an income, a credit score, a loan history, clearinghouse data, asset information, dependents information, and a transaction history of the target individual.

8. An apparatus comprising:
a harvesting engine configured to obtain non-virtual behavioral data of a target individual relating to a financial position of a target individual and virtual behavioral data by the target individual; and
a prediction engine configured to:
train an inference model using the non-virtual behavioral data and the virtual behavioral data;
make, using the trained inference model, a determination that the target individual is likely to conduct a non-virtual activity;
generate an actionable step based on the determination; and
cause execution of the actionable step.

9. The apparatus of claim 8, wherein obtaining the behavioral data further comprises:
generating, by the harvesting engine, a virtual activity;
providing, by communications hardware of the apparatus, the virtual activity to the target individual; and
obtaining, by the harvesting engine, the virtual behavioral data as the target individual completes the virtual activity.

10. The apparatus of claim 9, wherein the virtual activity is a financial simulation activity, the virtual behavioral data is obtained from a financial simulation profile of the target individual, and the financial simulation profile is generated as the target individual completes the financial simulation activity.

11. The apparatus of claim 8, wherein making the determination that the target individual is likely to conduct the non-virtual activity further comprises:
obtaining, by the harvesting engine, a first virtual behavior of the target individual, wherein the first virtual behavior is one of the virtual behavioral data; and
generating, by the inference model trained by the prediction engine, the non-virtual activity based on the first virtual behavior.

12. The apparatus of claim 11, wherein generating the actionable step further comprises:
generating, by the prediction engine and for the target individual, an output including at least one of:
a service associated with the non-virtual activity;
a course of action associated with the non-virtual activity; and
a virtual activity associated with the non-virtual activity.

13. The apparatus of claim 12, wherein causing execution of the actionable step further comprises:
providing, by communications hardware of the apparatus, the output to the target individual; and
in an instance where the virtual activity associated with the non-virtual activity is provided to the target individual:
the harvesting engine is further configured to obtain supplemental virtual behavioral data based on the target individual's completion of the virtual activity; and
the prediction engine is further configured to:
retrain the inference model using the supplemental virtual behavioral data to obtain an updated inference model;
generate, using the updated inference model, an updated actionable step for the non-virtual activity; and
cause execution of the updated actionable step.

14. The apparatus of claim 11, wherein the non-virtual behavioral data comprises at least one of an income, a credit score, a loan history, clearinghouse data, asset information, dependents information, and a transaction history of the target individual.

15. A computer program product comprising at least one non-transitory computer-readable storage medium storing software instructions that, when executed by an apparatus, causes the apparatus to:
obtain behavioral data including non-virtual behavioral data relating to a financial position of a target individual and virtual behavioral data by the target individual;
train an inference model using the non-virtual behavioral data and the virtual behavioral data;
make, using the trained inference model, a determination that the target individual is likely to conduct a non-virtual activity;
generate an actionable step based on the determination; and
cause execution of the actionable step.

16. The computer program product of claim 15, wherein obtaining the behavioral data further comprises:
generating a virtual activity;
providing the virtual activity to the target individual; and
obtaining, the virtual behavioral data as the target individual completes the virtual activity.

17. The computer program product of claim 16, wherein the virtual activity is a financial simulation activity, the virtual behavioral data is obtained from a financial simulation profile of the target individual, and the financial simulation profile is generated as the target individual completes the financial simulation activity.

18. The computer program product of claim 15, wherein making the determination that the target individual is likely to conduct the non-virtual activity further comprises:
obtaining a first virtual behavior of the target individual, wherein the first virtual behavior is one of the virtual behavioral data; and
generating the non-virtual activity based on the first virtual behavior.

19. (canceled)

20. (canceled)

21. The method of claim 5 wherein:
the service relates to modifying the financial position of the target individual;
the course of action relates to modifying the financial position of the target individual; and
the virtual activity relates to modifying the financial position of the target individual.

22. The method of claim 1, wherein causing, by the prediction engine, execution of the actionable step comprises performing at least one action from a set of actions comprising:
causing a physical notification to be sent to the target individual;
causing a digital notification to be sent to the target individual; and
assigning, to the target individual, a financial advisor.
